(19) United States
(12) Patent Application Publication
(10) Pub. No.: US 2008/0123665 A1
(43) Pub. Date: May 29, 2008

(54) UWB SENSOR ARRAY NETWORK STRUCTURE

(75) Inventors: Dongson Zeng, Germantown, MD (US); John B. Mckitterick, Columbia, MD (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/563,923

(22) Filed: Nov. 28, 2006

(51) Int. Cl. H04L 12/28

(52) U.S. Cl. 370/400

(57) ABSTRACT

A communication center that has communication as well surveillance capabilities is provided. The communication center includes a server and a plurality of UWB nodes. The server is configured to implement a medium assess control (MAC). The plurality of ultra-wideband (UWB) nodes are in communication with the server. Moreover, each UWB node of the communication center is controlled at least in part by the MAC.

### BACKGROUND

Ultra-wideband (UWB) radio units can serve as both a high-speed communication unit and a precise surveillance radar unit. Traditional communication systems commonly employ Medium Access Control (MAC). A MAC or MAC layer is a networking protocol layer that controls communications such as transmission requests, authentication and other overheads in a network. Although the communication functions of an UWB system could benefit from the use of a MAC layer, the surveillance functions of the UWB system are not contemplated by MAC. Hence, simply applying traditional MAC mechanisms of communication networks to an UWB communication and surveillance network is not suited to maximize the benefits of UWB radios. How to design a sensor network to accommodate both communication and surveillance capabilities of UWB radios is desired.

For the reasons stated above and for other reasons stated below which will become apparent to those skilled in the art upon reading and understanding the present specification, there is a need in the art for a novel communication and surveillance network structure of UWB sensor arrays and a novel multidimensional division multiple access (MDMA) technique which bridges the gaps between the communication and the surveillance capabilities of UWB sensor arrays.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention. In one embodiment a communication center is provided. The communication center includes a server and a plurality of UWB nodes. The server is configured to implement a medium assess control (MAC). The plurality of ultra-wideband (UWB) nodes are in communication with the server. Moreover, each UWB node of the communication center is controlled at least in part by the MAC.

### BRIEF DESCRIPTION OF THE DRAWINGS

The present invention can be more easily understood and further advantages and uses thereof more readily apparent, when considered in view of the detailed description and the following figures in which:

FIG. 1 is a block diagram of an UWB array network of one embodiment of the present invention;

FIG. 2 is a state diagram illustrating an MDMA algorithm of one embodiment of the present invention; and

FIG. 3 is a block diagram of another embodiment of an UWB array network of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide a communication and surveillance network of arrays of UWB nodes that implement a MAC (or MAC layer). A UWB node array network of embodiments consists of multiple local centers, which can function as either hosts or clients or both. Each local center has a server and multiple UWB nodes. In one embodiment, the links between the server and UWB nodes inside a local center are wired and the links between UWB nodes from different local centers are wireless. Moreover, in embodiments, multiple UWB transceivers share a single MAC which resides in a common server.

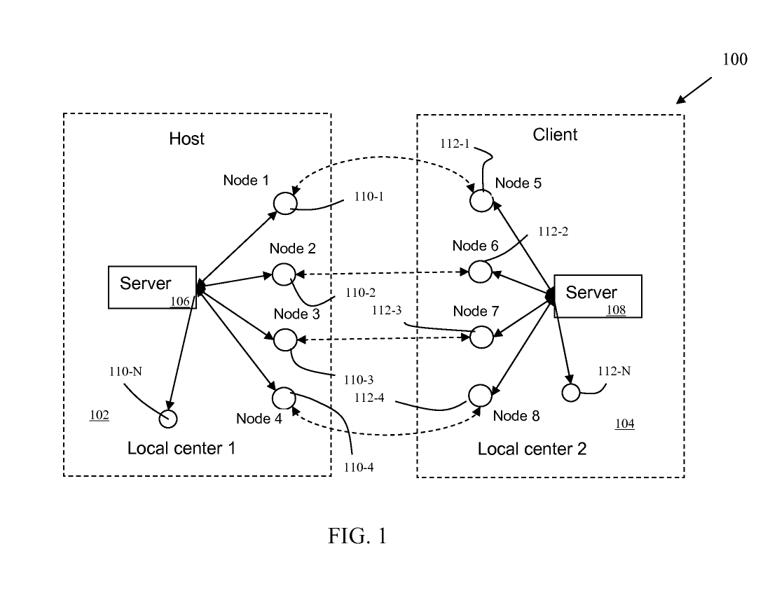

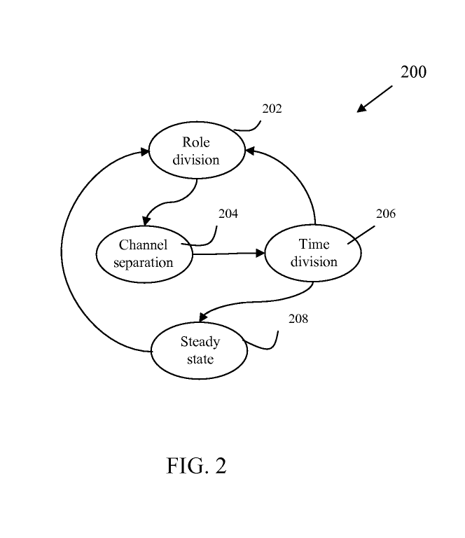

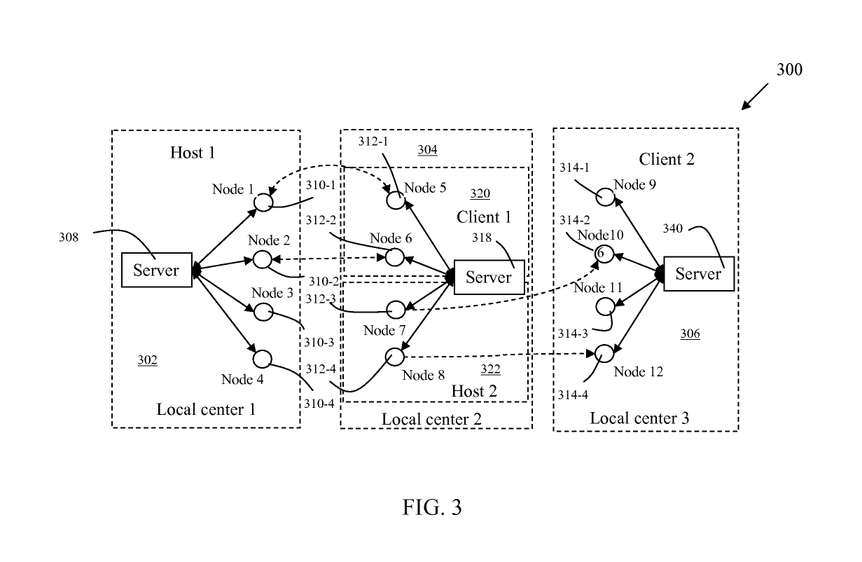

Referring to FIG. 1, a block diagram of UWB array network 100 of one embodiment of the present invention is illustrated. As illustrated, two local centers, local center 102 and local center 104 are shown. Although, only two local centers 102 and 104 are shown, more local centers could be used as illustrated in FIG. 3. The local centers 102 and 104 of FIG. 2 (or communication centers) may be vehicles or stationary objects. Each local center 102 and 104 includes a server and a plurality of nodes. In particular, local center 102 includes nodes 110 (1-N) and server 106 and local center 104 includes nodes 112 (1-N) and server 108. Each node 110 (1-N) and 112 (1-N) includes a UWB transceiver (or UWB sensor). The nodes 110 (1-N) and 112 (1-N) are placed in different locations within the respective local centers 102 and 104. Moreover, in embodiments, one or more sensors in a local center are positioned to detect UWB signals from different directions. The server 106 and 108 in the respective local centers 102 and 104 include the MAC layer that controls the respective nodes 100 (1-N) and 112 (1-N).

In one embodiment, multi-dimension division multiple access (MDMA) that includes channel separation, time division and host-client role division seamlessly incorporates various surveillance and communication services in the arrangement as set out in FIG. 1 to form network 100 having high reliability, fault tolerance and determinism. FIG. 2 illustrates a high level state diagram 200 of MDMA algorithms used in some embodiments of the present invention. At start up, a local center 102 or 104 is preconfigured to search in a steady state with all nodes sending out a beacon signal in each communication frame and changing into receiving mode during the rest of the frame. Beacon time slots are different for each node in order to avoid collisions since the search channel is common for all local centers. Once another local center is detected, the two local centers 102 and 104 negotiate their roles (202). That is, the local centers 102 and 104 decide who should be the host and who should be the client. The elected host then uses one designated node to broadcast beacon signals to keep different local centers synchronized and informed of the time division and channel separation.

In one embodiment multiple channels are established to accommodate multiple service simultaneously using code division multiple access (CDMA). In the embodiment illustrated in FIG. 2, different channels are separated by different pseudo-random code sequences which are known prior by both the host and the client (204). In an embodiment where UWB pulses use different frequency bands, multiple channels are separated by frequency division multiple access (FDMA) (204). Moreover, in the embodiment of FIG. 2, different services are scheduled with time division multiple access (TDMA) (206). By carefully assigning time slots to each service, deterministic latency and QoS are guaranteed. The host uses one node to broadcast a beacon signal which has a time schedule and code sequence information for all the nodes. Once the role division, channel separation and time division are determined, the network goes into a steady state where all services are delivered and QoS is guaranteed. When new service requests, fault detections, network topology changes, etc. take place, the old steady state is broken and the network will once again go through role division, channel separation and time division until it once again reaches a steady state.

An example of a network 300 with more than two local centers is illustrated in FIG. 3. As illustrated in FIG. 3, a first local center (302) includes server 308 and nodes 310 (1-4). A second local center 304 includes server 318 and nodes 312 (1-4) and a third local center 306 includes server 340 and nodes 314 (1-4). In the example of FIG. 3, nodes 310 (1-4) in the first local center 302 cannot directly communicate with nodes 314 (1-4) in the third local center 306. In this scenario, multiple hosts are used. In FIG. 3, nodes 312-1 and 312-2 in local center 320 can only connect to nodes 310-1 and 310-2 respectfully in local center 302 and nodes 312-3 and 312-4 in local center 304 can only connect to nodes 314-2 and 314-4 respectfully in local center 306. In one embodiment, all local centers 302, 304 and 306 are formed into a single network 300 through role division. For example, server 308 of the first local center 302 serves as host and server 318 of the second local center 304 serves as both client and host. In particular, the first local center 302 serves as a first host whose clients 320 are nodes 312-1 and 312-2 of the second local center 304. Moreover, as illustrated in FIG. 3, nodes 312-3 and 312-4 of the second local center 304 form a second host 322 to a second client that is the third local center 306. In the example of FIG. 3, the second host 322 of nodes 312-3 and 312-4 are in communication to clients made up of nodes 314-2 and 314-4 respectfully. The arrangement of FIG. 3 is made by way of example and not by way of limitation. Other arrangements are contemplated. For example, nodes 312-3 and 312-4 could also connect to nodes 310-3 and 3104 respectively. In this scenario, nodes 312-3 and 312-4 would provide host communications with nodes 314-2 and 314-4 of the third local center 306 and client communications with nodes 310-3 and 310-4 of the first local center 302 (though in a different time slot than when communicating with the third local center 306).

The UWB sensor array networks 100 and 300 as illustrated in FIGS. 1 and 3 provide various services. For example, the UWB array network may provide rangefinder functions. This function is accomplished when two UWB nodes in an array network calculate the distance between themselves by sending and receiving short messages and measuring the transit time of the signals. Another function includes intrusion detection. In this function two UWB nodes in an array network work as a bi-static radar pair with one a transmitter and the other a receiver. By detecting the received pulse energy, the UWB receiver can detect whether an object has intruded into a pre-defined area around the transmitter and receiver. Another function relates to tracking and collision avoidance. In this function, UWB sensor arrays are used as mono-static radars to scan, track and possibly avoid colliding into other objects in nearby space. Still another function includes deterministic communication. In this function, the time instant and duration of time slots are reserved so that latency of data bits is fixed or deterministic. Its ideal applications include real-time close-loop control information and actuator data. Another function includes real-time communication. In real time communication, the overall data rate is guaranteed but the response latency is not strictly the same for all the data packets, e.g. in video and audio streaming applications. Yet another function includes non-real-time communication. In a non-real-time communication, correct data delivery and maximum delay time are the only two requirements and the latency and delay time are not critical to the application. The above services are made by way of examples and not by way of limitation. Other services are contemplated.

The UWB sensor array networks 100 and 300 as illustrated in FIGS. 1 and 3 provide advantages over other communication systems. For example, the array networks provide location-awareness. Since each local center has multiple nodes with UWB sensors in different locations, the local center can calculate its location in 3D space. This is accomplished with three or more nodes reflecting range pulses of objects to determine distances to the objects and using triangulation techniques on the distance determinations to determine location information. Another advantage relates to fault tolerance. In embodiments of the present invention if a node is broken, another node in a respective local center is substituted. Still another advantage relates to fault resolution. When one node is determined to not be working well, the respective local center resets the malfunctioning node while one or more other nodes in the local center remain working. Yet another advantage is with embodiments in which predictable outages of nodes can be determined and addressed. In particular, since relative position of local centers can be precisely determined as discussed above, each local center can predict when one or more of its nodes will lose connections to nodes in other local centers and take action accordingly. Another advantage of embodiments of the networks is that deterministic latency can be handled. In particular, since TDMA is used in the MAC layer, deterministic latency can be managed. Still yet another advantage is that embodiments provide high reliability since the system will still function even when one or more UWB sensors in the nodes fail.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A communication center comprising:
a server configured to implement a medium access control (MAC); and
a plurality of ultra-wideband (UWB) nodes in communication with the server, wherein each UWB node of the communication center is controlled at least in part by the MAC.

2. The communication center of claim 1, wherein each UWB node further comprises a UWB transceiver adapted to communicate with other UWB nodes in other communication centers.

3. The communication center of claim 2, wherein the UWB transceiver in at least one UWB node is positioned to receive and transmit UWB signals in a different direction than other UWB transceivers in other UWB nodes.

4. The communication center of claim 1, wherein in the server is further configured to act as at least one of a host and a client.

5. The communication center of claim 1, wherein the communication system is a vehicle.

6. A communication network comprising:
at least two local centers, each local center including,
a server configured to implement a medium access control (MAC) layer, and
a plurality of nodes, each node including an ultra-wideband (UWB) transceiver, each node further in communication with the server, wherein each node of the plurality of nodes in the local center shares the MAC layer of the server.

7. The communication system of claim 6, wherein each UWB transceiver communicates wirelessly to other nodes in other local centers.

8. The communication system of claim 6, wherein the server in each local center is configured to act as at least one of a host and a client.

9. The communication system of claim 6, wherein the server in at least one of the local centers is configured to act as a host using select nodes for host communications and a client using select other nodes for client communications.

10. A method of implementing a communication and surveillance system, the method comprising:
controlling a plurality of ultra-wideband (UWB) nodes in a first local center with a single medium access control (MAC) implemented by a server in the first local center.

11. The method of claim 10, further comprising:
controlling a plurality of UWB nodes in a second local center with a single MAC implemented by a server in the second local center; and
communicating between select UWB nodes in the first local center with select nodes in the second local center.

12. The method of claim 11, further comprising:
using select USB nodes in at least one of the first and second local centers for host communications and
using other select nodes in the same local center for client communications.

13. The method of claim 11, further comprising:
determining host and client roles between the first and second local centers.

14. The method of claim 13, further comprising:
accommodating multiple services between the first and second local centers.

15. The method of claim 14, further comprising:
broadcasting beacon signals from a designated node of the host to keep the second local center synchronized and informed of time division and channel separation.

16. The method of claim 14, wherein accommodating multiple services between the first and second local centers, further comprises:
using code division multiple access (CDMA) to separate channels.

17. The method of claim 14, wherein accommodating multiple services between the first and second local centers, further comprises:
using frequency division multiple access (FDMA) to separate channels.

18. The method of claim 14, wherein accommodating multiple services between the first and second local centers, further comprises:
scheduling different services via time division multiple access (TDMA).

19. The method of claim 14, wherein the multiple services comprise at least two of range-finding, intrusion detection, tracking and collision avoidance, deterministic communication, real-time communication and non-real time communication.

20. The method of claim 11, wherein at least one of the first and the second local centers is configured to accomplish at least one of the functions of location awareness, fault-tolerance, fault resolution, predictable outage, deterministic latency and relatively high reliability.
